(19) United States
(12) Patent Application Publication
(10) Pub. No.: US 2017/0284614 A1
(43) Pub. Date: Oct. 5, 2017

(54) DECORATIVE LIGHT WIRE

(71) Applicant: Kuo-Wei PAN, Hsinchu City (TW)

(72) Inventor: Kuo-Wei PAN, Hsinchu City (TW)

(21) Appl. No.: 15/085,131

(22) Filed: Mar. 30, 2016

(51) Int. Cl. F21S 4/10; F21V 23/00

(52) U.S. Cl. CPC F21S 4/10; F21V 23/001; F21W 2121/04

(57) ABSTRACT

The present invention provides a strengthened decorative light wire. The decorative light wire is for electrically connecting a plurality of lamps. Each decorative light wire comprises a plurality of untwisted conductor wires, an external insulating sheath wraps around the plurality of conductor wires and one or more flat elongated strengthening sheets disposed between a inner surface and a outer surface of the external insulating sheath by enabling the flat elongated strengthening sheet/s to fully or partially, within the external insulating sheath, surround the conductor wires.

### FIELD OF THE INVENTION

The present invention relates to a decorative light set, and more particularly to a strengthened decorative light wire.

### BACKGROUND OF THE INVENTION

The use of decorative light sets during holiday season for drawing public attention is well known in the art. Decorative light sets typically include 16 to 24 lights connected in series via a decorative light wire which comprises multiple bronze wires enclosed by an insulating layer.

For safety concern, such decorative light wires used in the decorative light sets should meet various safety standards of mechanical properties such as tensile strength. To meet the tensile strength standard, 22 AWG (American Wire Gauge) wire is used as the decorative light wire of the decorative light set in which several 22 AWG wires are twisted together and covered with an insulating sheath. Moreover, two decorative light wires further twist together to form a twisted wire which meets the tensile strength standard.

U.S. Pat. No. 9,157,588 B2 (filed on Jul. 10, 2014, and claims the benefit of U.S. Provision Application No. 61/877,854 filed on Sep. 13, 2013) discloses a kind of decorative light set provided with a reinforcing strand enclosed by twisted conductive wires surrounding the reinforcing strand.

The production of the above mentioned decorative light set leads to the waste of wires which increase material cost. Besides, the reinforcing strand and the twisted conductor wires make the decorative light set heavier and bulkier.

### SUMMARY OF THE INVENTION

Therefore, the purpose of the present invention is to provide a strengthened decorative light wire used in a decorating light set with enhanced tensile strength and without twisted conductor wires to save material cost.

The technical means used by the present invention to overcome the drawbacks in prior art provides a decorative light wire for electrically connecting a plurality of lamps, comprising: a plurality of conductor wires, which is not twisted; an external insulating sheath including an inner surface and an outer surface, wherein the external insulating sheath covers the plurality of conductor wires, and the inner surface of the external insulating sheath faces toward the conductor wires such that the plurality of conductor wires are wrapped by the external insulating sheath; and one or more flat elongated strengthening sheets disposed between the inner surface and the outer surface of the external insulating sheath by enabling the flat elongated strengthening sheet/s to fully or partially, within the external insulating sheath, surround the conductor wires, in which the flat elongated strengthening sheet/s longitudinally extend/s along a direction parallel to a central longitudinal axis of the external insulating sheath, wherein the flat elongated strengthening sheet includes a sheet inner surface and a sheet outer surface, the sheet inner surface is allocated to face the inner surface of the external insulating sheath and the sheet outer surface is allocated to face the outer surface of the external insulating sheath.

In one embodiment of the present invention, a cross section of the flat elongated strengthening sheet is in arc shape, and the plurality of conductor wires are partially surrounded by the flat elongated strengthening sheet.

In one embodiment of the present invention, the one or more flat elongated strengthening sheets are mesh sheets.

In one embodiment of the present invention, a plurality of gaps exists between the plurality of conductor wires.

In one embodiment of the present invention, the flat elongated strengthening sheet is made of a polyethylene terephthalate (PET).

In one embodiment of the present invention, the external insulating sheath is made of a polyvinyl chloride (PVC).

In one embodiment of the present invention, the one or more flat elongated strengthening sheets exhibit tensile strength in a range from 45 to 65 MPa.

The decorative light wire of the present invention solves the problem of wire waste and the problem of the light set being heavier and bulkier in the prior art. By the technical means used by the present invention, the flat elongated strengthening sheet provides the decorative light wire with increased tensile strength. Accordingly, the conductor wires need not be twisted so the cost of the decorative light wire is reduced and the size of the decorative light wire is thinner and lighter.

### BRIEF DESCRIPTION OF THE DRAWINGS

FIG. 1 is a plan view of a decorative light set with strengthened, series-connected decorative light wires according to a first embodiment of the present invention;

FIG. 2 is a cross-sectional view illustrating the decorative light wire according to the first embodiment of the present invention;

FIG. 3 is a structural view illustrating the decorative light wire according to the first embodiment of the present invention;

FIG. 4 is a cross-sectional view illustrating a decorative light wire according to a second embodiment of the present invention;

FIG. 5 is a cross-sectional view illustrating a decorative light wire according to a third embodiment of the present invention;

FIG. 6 is a cross-sectional view illustrating a decorative light wire according to a fourth embodiment of the present invention;

FIG. 7 is a cross-sectional view illustrating a decorative light wire according to a fifth embodiment of the present invention.

### DETAILED DESCRIPTION OF THE PREFERRED EMBODIMENTS

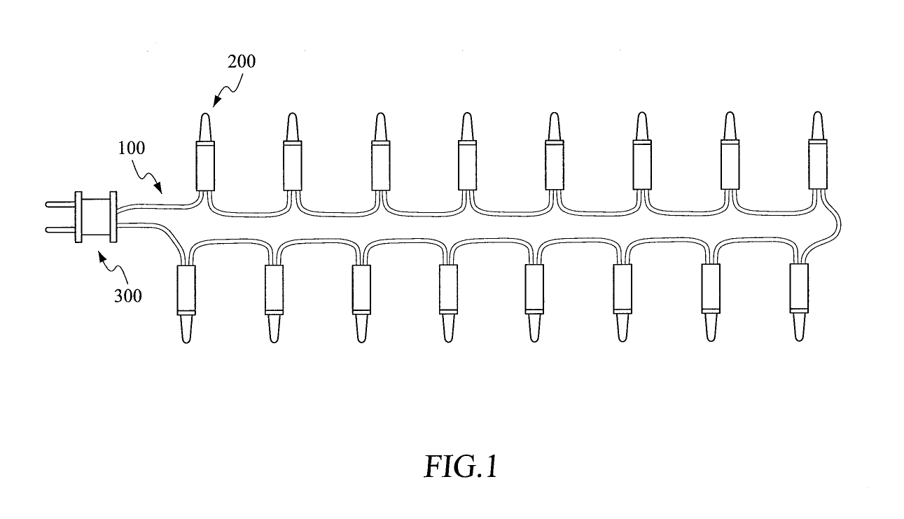

The implementation of the present invention is described below with reference to FIG. 1 to FIG. 7. The descriptions herein are not to be construed as limitations on the scope of the present invention, but as examples of the preferred embodiments of the present invention.

Please refer to FIG. 1. A decorative light wire 100 for electrically connecting sixteen lamps 200 in series is connected with a power plug 300. It goes without saying that the present invention is not limited to this. The decorative light wire 100 and the lamps 200 can form circuit arrangement of other kinds, such as a parallel circuit or a combination of parallel and series circuit.

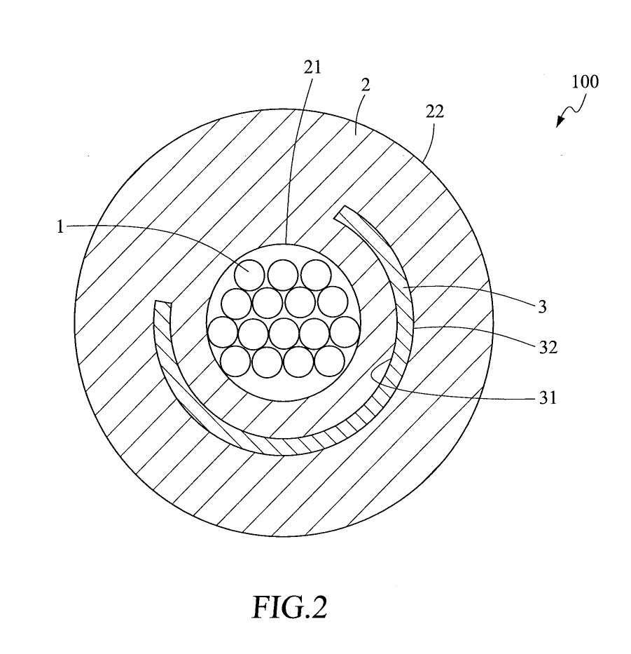

Please refer to the cross-sectional view of the decorative light wire 100 in FIG. 2. In the present embodiment, the decorative light wire 100 includes sixteen conductor wires 1 which are not twisted. It goes without saying that the present invention is not limited to this. In other embodiments, the number of the conductor wires 1 can be more than sixteen or less than sixteen as long as the electrical properties of the conductor wires 1 are similar to that of the conductor wires of a decorative light set in prior art. A plurality of gaps exists between the conductor wires 1, which provide flexibility when the decorative light wire 100 is bent.

The decorative light wire 100 according to the first embodiment of the present invention contains an external insulating sheath 2 which includes an inner surface 21 and an outer surface 22, wherein the external insulating sheath 2 forms a tube that fully surrounds the sixteen conductor wires 1, and the inner surface 21 of the external insulating sheath 2 faces toward the conductor wires 1 in a manner that the conductor wires 1 are located inside the tube and are wrapped by the external insulating sheath 2. The outer surface 22 forms the outer edge of the decorative light wire 100.

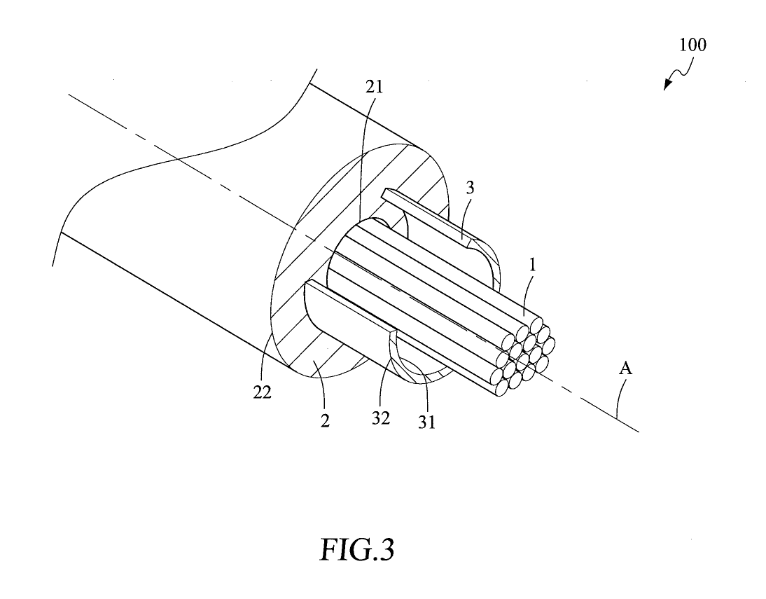

Please refer to FIG. 2 and FIG. 3. In the present embodiment, a decorative light wire 100 contains one flat elongated strengthening sheet 3 which is disposed between the inner surface 21 and the outer surface 22 of the external insulating sheath 2. The flat elongated strengthening sheet 3 longitudinally extends along a direction parallel to a central longitudinal axis A of the external insulating sheath 2. The central longitudinal axis A is disposed at the center of the decorative light wire 100. As the decorative light wire 100 is bent, the central longitudinal axis A is also bent.

In this embodiment, the cross section of the flat elongated strengthening sheet 3 is in arc shape and forms two-thirds of the circumference of a circle which partially surround the plurality of conductor wires 1. The flat elongated strengthening sheet 3 is sheet-shaped along the ring so that the thickness of the external insulating sheath 2 can be thin.

The flat elongated strengthening sheet 3 is made of polyethylene terephthalate (PET), and the external insulating sheath 2 is made of polyvinyl chloride (PVC). PET provides higher tensile strength than PVC. With PET as the material of the flat elongated strengthening sheet 3, the flat elongated strengthening sheet 3 exhibits tensile strength in a range from 45 to 65 MPa, which meets the safety standard, and thus the conductor wires 1 need not be twisted. Consequently, the volume of the conductor wires 1 and the material cost of the conductor wires 1 are reduced.

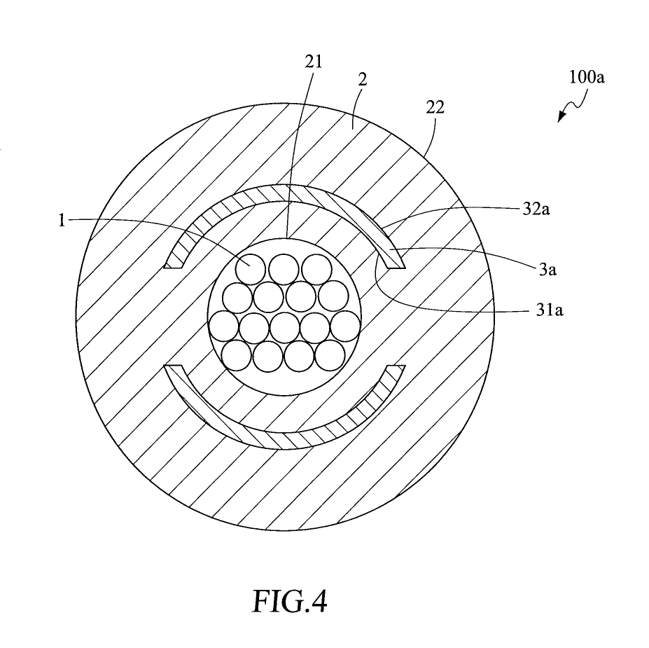

Please refer to FIG. 4, the second embodiment of the present invention provides a decorative light wire 100a similar to the decorative light wire 100 of the first embodiment. The major difference between the two embodiments is the number of the flat elongated strengthening sheet. In the second embodiment, there are two flat elongated strengthening sheets 3a which are located opposite to each other. In such way, the flat elongated strengthening sheets 3a provide support that strengthens the decorative light wire 100a more evenly than the flat elongated strengthening sheets 3 of the first embodiment.

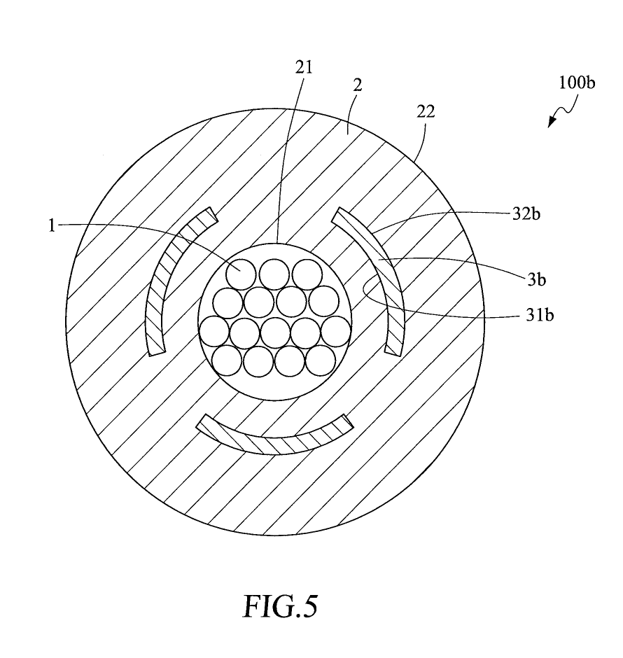

Please refer to FIG. 5, the third embodiment of the present invention provides a decorative light wire 100b similar to the decorative light wire 100a of the second embodiment. The major difference between the two embodiments is the number of the flat elongated strengthening sheet. In the third embodiment, there are three flat elongated strengthening sheets 3b which form half of the circumference of a circle. The flat elongated strengthening sheets 3b are evenly distributed around the conductor wires 1 of the decorative light wire 100b. The flat elongated strengthening sheets 3b provide support that strengthens the decorative light wire 100b more evenly than the flat elongated strengthening sheets 3a of the second embodiment.

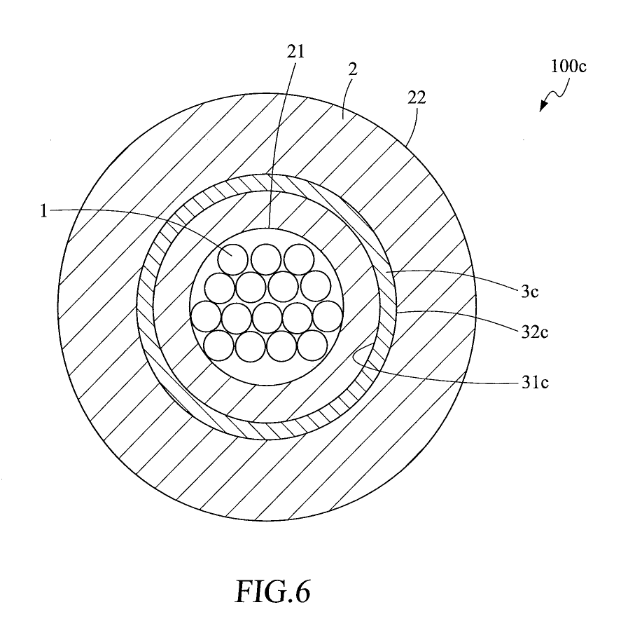

Please refer to FIG. 6, the fourth embodiment of the present invention provides a decorative light wire 100c similar to the decorative light wire 100 of the first embodiment. The major difference between the two embodiments is the shape of the flat elongated strengthening sheet. In this embodiment, there is only one flat elongated strengthening sheet 3c which forms the circumference of a circle. The flat elongated strengthening sheet 3c fully surrounds the conductor wires 1, thereby providing the highest tensile strength of the decorative light wire among the four already-mentioned embodiments.

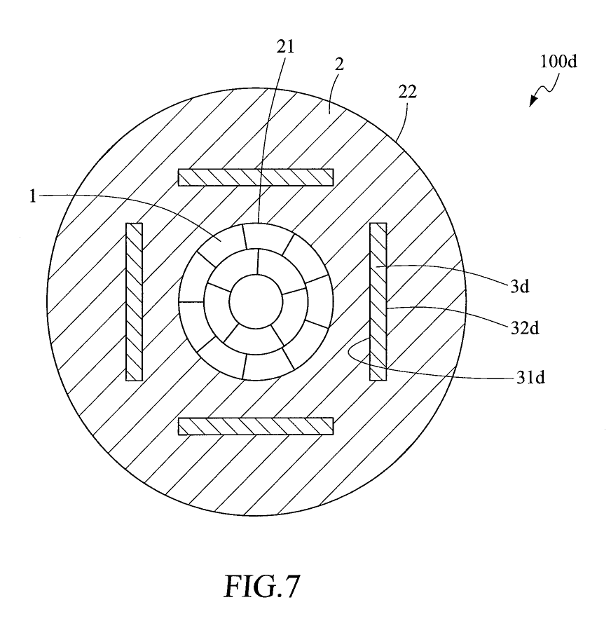

Please refer to FIG. 7, the fifth embodiment of the present invention provides a decorative light wire 100d similar to the decorative light wire 100 of the first embodiment. The major differences between the two embodiments are the shape of the flat elongated strengthening sheet and the shape of the conductor wires. In the fifth embodiment, there are four flat elongated strengthening sheets 3d which are distributed around the plurality of the conductor wires 1 and discontinuously form a rectangle. In the fifth embodiment, the plurality of conductor wires 1 is configured to fully fill the space inside the inner surface 21, and the plurality of gaps between the plurality of conductor wires 1 are thus eliminated, which reduces the space occupied by the decorative light wire 100d. The cross-sectional area of the plurality of conductor wires 1 of the fifth embodiment is the same as the cross-sectional area of the plurality of conductor wires 1 of the first embodiment of the present invention. Since the plurality of gaps between the plurality of conductor wires 1 are eliminated, the decorative light wire 100d of the fifth embodiment is thinner than the decorative light wire 100 of the first embodiment of the present invention.

In an embodiment of the present invention, the one or more flat elongated strengthening sheets 3 can be mesh sheets. With the flat elongated strengthening sheets 3 being mesh sheets, the volume of the flat elongated strengthening sheets 3 can be further reduced with little decrease of tensile strength.

The above description is only the description of the preferred embodiments of the present invention. However, a person with ordinary skill in the art may make various modifications to the present invention. Those modifications shall still fall within the spirit and the scope defined by the appended claims.

What is claimed is:

1. A decorative light wire for electrically connecting a plurality of lamps, comprising:
a plurality of conductor wires, which is not twisted;
an external insulating sheath including an inner surface and an outer surface, wherein the external insulating sheath covers the plurality of conductor wires, and the inner surface of the external insulating sheath faces toward the conductor wires such that the plurality of conductor wires are wrapped by the external insulating sheath; and
one or more flat elongated strengthening sheets disposed between the inner surface and the outer surface of the external insulating sheath by enabling the flat elongated strengthening sheet/s to fully or partially, within the external insulating sheath, surround the conductor wires, in which the flat elongated strengthening sheet/s longitudinally extend/s along a direction parallel to a central longitudinal axis of the external insulating sheath,
wherein the flat elongated strengthening sheet includes a sheet inner surface and a sheet outer surface, the sheet inner surface is allocated to face the inner surface of the external insulating sheath and the sheet outer surface is allocated to face the outer surface of the external insulating sheath.

2. The decorative light wire of claim 1, wherein a cross section of the flat elongated strengthening sheet is in arc shape, and the plurality of conductor wires are partially surrounded by the flat elongated strengthening sheet.

3. The decorative light wire of claim 1, wherein the one or more flat elongated strengthening sheets are mesh sheets.

4. The decorative light wire of claim 1, wherein a plurality of gaps exists between the plurality of conductor wires.

5. The decorative light wire of claim 1, wherein the flat elongated strengthening sheet is made of polyethylene terephthalate (PET).

6. The decorative light wire of claim 1, wherein the external insulating sheath is made of polyvinyl chloride (PVC).

7. The decorative light wire of claim 1, wherein the one or more flat elongated strengthening sheets exhibit tensile strength in a range from 45 to 65 MPa.
